(19) United States
(12) Patent Application Publication
(10) Pub. No.: US 2019/0183127 A1
(43) Pub. Date: Jun. 20, 2019

(54) CO-FORMULATIONS OF BIFENTHRIN WITH CROP PROTECTION AGENTS ABSORBED ON A CARRIER FOR USE WITH LIQUID FERTILIZERS

(71) Applicant: FMC Corporation, Philadelphia, PA (US)

(72) Inventor: Guozhi Wang, Oakland Gardens, NY (US)

(21) Appl. No.: 16/220,167

(22) Filed: Dec. 14, 2018

Related U.S. Application Data
(60) Provisional application No. 62/607,993, filed on Dec. 20, 2017.

(51) Int. Cl. A01N 53/00; A01N 57/16; A01N 25/04; C05G 3/02; C05G 3/00

(52) U.S. Cl. CPC A01N 53/00; A01N 57/16; C05G 3/0076; C05G 3/02; A01N 25/04

(57) ABSTRACT

Insecticidal compositions suitable for use in preparation of insecticidal liquid fertilizers are disclosed, the compositions comprising bifenthrin, an additional crop protection agent absorbed onto a carrier, a hydrated aluminum-magnesium silicate, at least one alkylpolyglycoside dispersant and optionally at least one additional dispersant selected from the group consisting of taurates, lignosulfonates, phosphate esters and polyvinylpyrrolidone.

### FIELD OF THE INVENTION

The present invention relates to the field of agrochemical compositions and formulations. In particular, the invention provides an insecticidal composition comprising bifenthrin in combination with a crop protection agent absorbed on a carrier, where the composition is suitable for use in the preparation of insecticidal liquid fertilizers.

### BACKGROUND OF THE INVENTION

To enable the efficient elimination or control of unwanted insects in combination with providing nutrients for plants to combat adverse environmental conditions (such as heat, drought, physical contact with animals, etc.) it is desirable to formulate an effective chemical insecticide for use in preparation of insecticidal liquid fertilizers. Formulations of insecticides combined with fertilizers are desirable in agricultural and related endeavors due to the multiple benefits conveyed by just one application in a single piece of equipment. One application of such a combination or formulation provides nutrients for the plant growth, while eliminating or controlling unwanted insects that can also affect the health and vitality of the desirable plants.

Mixtures containing insecticide compositions and liquid fertilizers have been practiced in the art, but problems with the physical stability of such mixtures have caused application and efficacy issues. When a traditional insecticidal composition is combined with a liquid fertilizer, the combined components (surfactants, viscosity modifiers, wetting agents) of both can cause accelerated physical degradation (phase separation) of the mixture. This physical degradation can occur in the mix tanks prior to application on the plants or to the locus of the plants (such as the soil around the plants). Often this problem goes unnoticed and results in inconsistent application of both the fertilizer and insecticide, yielding inadequate efficacy of both.

### SUMMARY OF THE INVENTION

In one aspect, the present invention is directed to an insecticidal composition comprising a) bifenthrin; b) at least one additional crop protection agent (other than bifenthrin) absorbed on a carrier, wherein the crop protection agent comprises a liquid at ambient temperature and pressure, or a low-melting having a melting point from about 20° C. to about 65° C. (at ambient pressure); c) a hydrated aluminum-magnesium silicate; and d) at least one alkylpolyglycoside dispersant and optionally at least one additional dispersant selected from the group consisting of taurates, lignosulfonates, phosphate esters and polyvinylpyrrolidone.

Embodiments of the insecticidal composition include:

The composition comprising a) about 1% to about 35% of bifenthrin; b) about 1% to about 30% of at least one crop protection agent, absorbed on a carrier; c) about 1% to about 20% of hydrated aluminum-magnesium silicate; and d) about 0.2% to about 20% of the dispersant component; where all % are % by weight based upon the total weight of all components in the composition.

The composition wherein d) consists essentially of the at least one alkylpolyglycoside dispersant; or d) comprises at least one alkylpolyglycoside dispersant and a taurate dispersant; or d) comprises at least one alkylpolyglycoside dispersant and a lignosulfonate dispersant; or d) comprises at least one alkylpolyglycoside dispersant and a phosphate ester dispersant; or d) comprises at least one alkylpolyglycoside dispersant and a polyvinylpyrrolidone dispersant.

The composition wherein the crop protection agent absorbed on a carrier is: a liquid at ambient temperature and pressure; or a low-melting solid having a melting point from about 20° C. to about 65° C.; or a low-melting solid having a melting point less than 60° C.; or a low-melting solid having a melting point less than 50° C.

The insecticidal composition wherein the crop protection agent absorbed on a carrier comprises an insecticide selected from the group consisting of anilofos, azinphos-ethyl, beta-cypermethrin, chlorpyrifos, esfenvalerate, fenoxycarb, fenvalerate, gamma-cyhalothrin, monocrotophos, pyridaphenthion, resmethrin, thiofanox, triazamate and zeta-cypermethrin; such as an insecticide selected from the group consisting of chlorpyrifos, gamma-cyhalothrin and zeta-cypermethrin.

The insecticidal composition wherein the crop protection agent absorbed on a carrier comprises a fungicide selected from the group consisting of dinocap, fenpropidin, fenpropimorph, imazalil, myclobutanil, nitrothal-isopropyl, penconazole, propamocarb hydrochloride, pyraclostrobin, spiroxamine, and propiconazole; such as a fungicide selected from the group consisting of pyraclostrobin and propiconazole.

The insecticidal composition wherein the crop protection agent absorbed on a carrier comprises a nematicide selected from the group consisting of cadusafos, dichlofenthion, ethoprophos, fensulfothion, fosthiazate, heterophos, isazofos, thionazin, mecarphon, fenamiphos, phosphocarb and benclothiaz.

The insecticidal composition wherein the hydrated aluminum-magnesium silicate is selected from the group consisting of montmorillonite and attapulgite.

The insecticidal composition wherein the carrier comprises clay, synthetic amorphous silica gel, hydrophilic silica, precipitated silica, or mixtures thereof.

The insecticidal composition described above is compatible with a liquid fertilizer to provide an insecticidal liquid fertilizer composition. As used herein, the term “compatible” means that an aqueous mixture of the insecticidal composition and a liquid fertilizer is homogeneous, with good physical stability and no phase separation or separation of the active ingredients from the mixture. Another aspect of the invention is directed to an insecticidal liquid fertilizer composition wherein the above insecticidal composition (or any embodiments thereof) further comprises a liquid fertilizer. Preferably the liquid fertilizer is aqueous-based. Preferably the liquid fertilizer is present in a concentration of about 95.0% by weight to about 99.99% by weight based on the total weight of all components in the insecticidal liquid fertilizer composition. Preferably, the other components of the insecticidal liquid fertilizer composition include bifenthrin in about 0.75% to about 1.25%, the crop protection agent absorbed on a carrier in about 0.75% to about 1.25%, the hydrated aluminum-magnesium silicate in about 0.05% to about 1.0%, and the dispersant in about 0.1% to about 0.75% by weight based on the total weight of all components in the composition.

Any of the compositions above may further comprise at least one additive selected from the group consisting of antifreeze agents, anti-foam agents and biocides.

The invention also provides a process for preparing a water dispersible insecticidal composition comprising: a) absorbing the crop protection agent onto a carrier, preferably precipitated silica; b) forming a mixture of bifenthrin or other high melting pyrethroid, a hydrated aluminum-magnesium silicate component, a dispersant component, and optionally, a preservative and/or biocide; and c) combining the mixture from step a) with that of step b).

The invention also provides a method for controlling insects comprising applying an insecticidally effective amount of any of the compositions above to a locus where insect control is needed or expected to be needed.

The invention also provides a method of controlling unwanted insects and providing nutrients to plants, wherein the method includes applying to an area infested with such insects and containing such plants an effective amount of a liquid fertilizer in combination with an insecticidal composition of this invention, including any of the embodiments described above.

The invention also provides a use of any of the compositions above for controlling insects.

### DETAILED DESCRIPTION OF THE INVENTION

As used in this specification and unless otherwise indicated the term “crop protection agent” refers to a molecule or combination of molecules which express biological activity as a pesticide, arthropodicide, insecticide, acaricide, nematicide, fungicide, herbicide, plant growth regulator or a combination of two or more of these biological activities. As used in this specification and unless otherwise indicated the term “insecticide” refers to a molecule or combination of molecules that controls, repels, retards, or kills insects and/or reduces damage due to an insect infestation, and can be used for crop protection and/or turf protection. Some insecticides may also be suitable as arthropodicides, acaricides and/or nematicides. The term “fungicide” refers to a molecule or combination of molecules that controls, retards or kills fungal pathogens, prevents and/or cures infections by fungal pathogens, and/or reduces damage due to a fungal infestation, and can be used for crop protection and/or turf protection.

As used herein, the term “insecticidal composition” refers to a composition having insecticidal properties that does not also comprise a liquid fertilizer. As used herein the term “insecticidal liquid fertilizer composition” refers to a composition having insecticidal properties that also comprises a liquid fertilizer. The term “liquid fertilizer” refers to a fertilizer in a fluid or liquid form containing various ratios of nitrogen, phosphorous and potassium (for example, but not limited to, 5-15% nitrogen, 20-40% phosphorous and 0 to 10% potassium, such as 10% nitrogen, 34% phosphorous and 0% potassium) and micronutrients, commonly known as starter fertilizers that are high in phosphorus and promote rapid and vigorous root growth. Liquid fertilizers are commonly aqueous-based. As used herein, the term “aqueous-based” indicates that the predominant solvent or vehicle is water.

The term “ambient temperature” as used herein shall mean any suitable temperature found in a laboratory or other working environment, and is generally not below about 15° C., nor above about 30° C. The term “ambient pressure” as used herein shall mean any suitable pressure found in a laboratory or other working environment, generally around one atmosphere.

The modifier “about” is used herein to indicate that certain preferred operating ranges, such as ranges for molar ratios for reactants, material amounts, and temperature, are not fixedly determined. The meaning will often be apparent to one of ordinary skill. For example, a recitation of a temperature range of about 100° C. to about 125° C. in reference to, for example, an organic chemical reaction would be interpreted to include other like temperatures that can be expected to favor a useful reaction rate for the reaction, such as 90° C. or 135° C. Where guidance from the experience of those of ordinary skill is lacking, guidance from the context is lacking, and where a more specific rule is not recited below, the “about” range shall be not more than 10% of the absolute value of an end point or 10% of the range recited, whichever is less.

As used herein, “% by weight of all components in the total composition” includes the weight % of all liquid and solid components in the composition unless otherwise defined.

As is employed herein, the term “plants” includes agricultural, silvicultural and horticultural (including ornamental) plants. The term “plants” also includes genetically modified plants in which genetic material has been modified by the use of recombinant DNA techniques. Such techniques permit modifications that cannot readily be obtained by natural breeding or mutagenesis, such as, for example, cross-breeding under natural circumstances, natural mutations or natural recombination.

The composition according to the present invention may be applied to the propagative material by any means, including direct application, as a seed treatment, in furrow or band applications, by means well known to those in the art.

In accordance with the present invention, it has now been found that a new insecticidal composition significantly improves physical stability when used to prepare an insecticidal liquid fertilizer composition. Specifically, the present invention is directed to an insecticidal composition that includes bifenthrin, an additional crop protection agent absorbed on a carrier, a hydrated aluminum-magnesium silicate, at least one alkylpolyglycoside dispersant and optionally at least one additional dispersant selected from the group consisting of taurates, lignosulfonates, phosphate esters and polyvinylpyrrolidone.

A particularly difficult combination to formulate is a liquid-fertilizer-ready combination of a high-melting solid active ingredient, for example bifenthrin, with a liquid or low-melting solid active ingredient, for example another insecticide such as cypermethrin, zeta-cypermethrin or chlorpyrifos. As disclosed herein, absorption of the liquid or the low-melting solid active ingredient on a carrier protects the formulation from degradation during preparation, storage and/or application conditions, such as wherein the fluidity of the liquid active ingredient or the melting point of the low-melting active ingredient might be approached or exceeded results in instability of the formulation.

Besides bifenthrin, other high-melting pyrethroids can be employed in this invention. The preferred high melting pyrethroids include, without limitation, alpha-cypermethrin, beta-cypermethrin, bifenthrin, cyfluthrin, beta-cyfluthrin, deltamethrin, and tralomethrin, more particularly, the pyrethroid is bifenthrin. For the purposes of the present invention, a “high melting” compound has a melting point of about 70° C. or greater, and a “low melting” compound has a melting point of about 20° C. to about 65° C., or less than 50° C., or less than 60° C. Bifenthrin, or other high-melting pyrethroid is preferably present in a concentration of from about 1.0% by weight to about 25% by weight, more particularly, from about 15% by weight to about 25% by weight based upon the total weight of all components in the insecticidal composition. In one embodiment, the high-melting pyrethroid is bifenthrin. Preferably, the high-melting pyrethroid is not absorbed on a carrier or encapsulated. In another embodiment, the high-melting pyrethroid is unabsorbed or nonencapsulated bifenthrin.

In one embodiment, the crop protection agent absorbed on a carrier is an insecticide and is one or more selected from the group consisting of azinphos-ethyl, chlorpyrifos, esfenvalerate, fenoxycarb, fenvalerate, gamma-cyhalothrin, monocrotophos, pyridaphenthion, resmethrin, thiofanox, triazamate and zeta-cypermethrin.

Insecticides that are liquids or viscous liquids at ambient temperature and pressure include fenvalerate and zeta-cypermethrin. Low melting solid insecticides that have melting points from 60 to about 65° C. include pyridaphenthion. Low melting solid insecticides that have melting points from 50 to about 60° C. include anilofos, azinphos-ethyl, esfenvalerate, fenoxycarb, monocrotophos, thiofanox and triazamate. Low melting solid insecticides that have melting points from about 20 to about 50° C. include chlorpyrifos, gamma-cyhalothrin and resmethrin.

In a preferred embodiment, the crop protection agent is an insecticide, which is one or more selected from the group consisting of chlorpyrifos, gamma-cyhalothrin and zeta-cypermethrin. In one specific embodiment the absorbed insecticide is zeta-cypermethrin. In another specific embodiment the absorbed insecticide is chlorpyrifos. In another specific embodiment the absorbed insecticide is gamma-cyhalothrin.

In one embodiment, the absorbed crop protection agent is a fungicide and is one or more selected from the group consisting of dinocap, fenpropidin, fenpropimorph, imazalil, myclobutanil, nitrothal-isopropyl, penconazole, propamocarb hydrochloride, pyraclostrobin, spiroxamine, and propiconazole.

Fungicides that are liquids at ambient temperature and pressure include dinocap, fenpropidin, fenpropimorph, spiroxamine and propiconazole. Low melting solid fungicides that have melting points from 60 to 65° C. include myclobutanil, nitrothal-isopropyl, propamocarb hydrochloride and pyraclostrobin. Low melting solid fungicides that have melting points from 20 to about 60° C. include imazalil and penconazole.

In a preferred embodiment, the crop protection agent is a fungicide, which is one or more selected from the group consisting of pyraclostrobin and propiconazole. In one specific embodiment the absorbed fungicide is pyraclostrobin. In one specific embodiment the absorbed fungicide is propiconazole.

In one embodiment, the absorbed crop protection agent is a nematicide and is one or more selected from the group consisting of cadusafos, dichlofenthion, ethoprophos, fensulfothion, fosthiazate, heterophos, isazofos, thionazin, mecarphon, fenamiphos, phosphocarb and benclothiaz.

Nematicides that are liquid under ambient conditions include cadusafos, dichlofenthion, ethoprophos, fensulfothion, fosthiazate, heterophos, isazofos or thionazin. Nematicides that are solids melting between 20 and 60 include mecarphon, fenamiphos, phosphocarb and benclothiaz.

In this invention, the crop protection agent other than bifenthrin or another high melting pyrethroid is absorbed onto an appropriate carrier (% loading) in a range of from 40% to 65% loading by weight of the crop protection agent and the carrier, preferably from 50% to 62% loading, or 50% to 56% loading. The carrier must be able to absorb an adequate amount crop protection agent in order to provide an insecticidally, fungicidally, or nematicidally effective amount in the insecticidal composition. The loaded carrier should be free flowing and yield excellent dispersion properties in the final insecticidal composition. By “free flowing” it is meant that the loaded carrier is not sticky, is free of clumps, and may be easily poured. Appropriate carriers include, for example, clays, synthetic amorphous silica gels, hydrophilic silicas and precipitated silicas, or mixtures thereof.

In one embodiment, the clay may be selected from montmorillonite, attapulgite, and combinations thereof. In one embodiment, the clay has an average particle size of about 0.1 micron. The Attaflow® attapulgite products of BASF Corporation are representative.

In some embodiments, when the crop protection agent is absorbed onto a hydrated aluminum-magnesium silicate clay, the clay carrier may also serve as the hydrated aluminum-magnesium silicate component of the insecticidal composition.

Colloidal silicas include, but are not limited to, fumed silicas. In one embodiment, the fumed silica is a hydrophilic fumed silica. The Aerodisp® products of Evonik Industries are representative. In a preferred embodiment, the crop protection agent is absorbed onto precipitated silica in a loading by weight of between 52% and 56%. A preferred precipitated silica is Hi-Sil® ABS from PPG Industries.

When using a crop protection agent loaded onto a carrier such as precipitated silica, the loaded carrier can be present in range of from about 2% to about 55% by weight of all the components in the total insecticidal composition. This range equates to a crop protection agent concentration of about 1% to about 30% by weight of all the components in the total insecticidal composition. In a more preferred embodiment, the loaded carrier can be present in range of from 35% to 40% by weight of all the components in the total insecticidal composition. This preferred range equates to a crop protection agent concentration of from about 18% to about 22% by weight of all the components in the total insecticidal composition.

The hydrated aluminum-magnesium silicate is preferably selected from montmorillonite and attapulgite.

Dispersants or dispersing agents are substances added to suspension of solid particles typically colloidal suspension to improve the separation of the particles and to decrease or prevent settling or clumping. The dispersant component of the insecticidal composition comprises at least one alkylpolyglycoside dispersant and optionally at least one additional dispersant selected from the group consisting of taurates, lignosulfonates, phosphate esters and polyvinylpyrrolidone. The dispersant or dispersants are present in a total concentration of from about 0.02% by weight to about 20% by weight based upon the total weight of all components in the insecticidal composition. Preferably, the (total) dispersant component can be present in a range of from about 10% to 20%, more preferably in a range of from about 15% to 20% by weight of all the components in the total insecticidal composition.

The dispersant component of the insecticidal composition comprises at least one alkyl alkylpolyglycoside, preferably comprising C₈-C₁₄ alkyl groups. The Agnique® products of BASF Corporation (Cognis) are representative. In one embodiment, the alkyl d-glycopyranoside surfactant includes a mixture of C₈-C₁₀ alkyl d-glucopyranosides, such as Agnique® PG8105-G. In another embodiment, the alkyl d-glucopyranoside surfactant includes a mixture of C₉-C₁₁ alkyl d-glucopyranosides. A preferred product is Agnique® PG9116 which is a mixture of C₉-C₁₁ alkyl d-glucopyranosides, having a degree of polymerization of about 1.6 and a hydrophilic-lipophilic balance (HLB) of about 13.1.

The dispersant component of the composition optionally comprises a lignosulfonate. The optional lignosulfonate is preferably a kraft lignosulfonate. Examples of commercially available kraft lignosulfonates include Polyfon® O, Polyfon® T, Polyfon® H, Kraftsperse® EDF, Reax® 88B and Reax® 907, all available from MeadWestVaco Inc. A preferred kraft lignosulfonate is Polyfon® O.

The dispersant component of the composition optionally comprises a taurate dispersant. Taurates (or taurides) are anionic acylamino alkane surfactants, preferably N-methyl-N-acyl taurates comprising a C₁₀ to C₁₈ acyl group. such as sodium oleoyl N-methyl taurate, sodium lauroyl N-methyl taurate, sodium cocoyl N-methyl taurate, sodium myristoyl N-methyl taurate or mixtures thereof. An example of a preferred taurate is Geropon® T-77, a sodium oleoyl N-methyl taurate available from Solvay Novecare.

The optional phosphate ester dispersant comprises phosphate esters of alcohols, ethoxylated alcohols or ethoxylated phenol. They can be in the free acid form or neutralized as the sodium, potassium or ammonium salts. The Dextrol® products of Ashland Corporation are representative, such as Dextrol® OC-180. The phosphate ester is preferably selected from a nonyl phenol phosphate ester and a tridecyl alcohol ethoxylated phosphate potassium salt.

Another dispersant is polyvinylpyrrolidone (PVP), a water soluble polymer. An example PVP is PVP K-30 polymer available from Ashland Corporation.

When the alkyl polyglycoside dispersant is combined with one or more optional dispersant selected from taurates, lignosulfonates, phosphate esters or polyvinylpyrrolidone, the ratio of alkyl polyglycoside to other dispersant(s) may be from 10:1 to 1:10, from 1:3 to 3:1, or from 2:1 to 1:2. In some embodiments, the alkyl polyglycoside comprises at least 50% of the total dispersant component.

Optionally, the insecticidal composition further includes at least one of the additives selected from antifreeze agents, anti-foam agents, biocides and/or preservatives. These formulation components are known in the agrochemical arts. In one embodiment, the antifreeze agent is a polyalkylene glycol, preferably propylene glycol, and when present, is present in an amount from about 5% to about 9% by weight of the total of all components in the composition. In an embodiment, the anti-foam agent is a silicone emulsion, for example Xiameter® AFE-0100 available from Dow Corning Corp or an alkylcyclotetrasiloxane, preferably an octamethylcyclotetrasiloxane silicone emulsion, for example, DowCorning® AF Emulsion or DowCorning ® Antifoam C Emulsion (Dow Corning Corporation). When present, the anti-foam agent is present in an amount of from about 0.001% to about 1% by weight of all the components in the total insecticidal composition. In another embodiment, the preservative (biocide) is an isothiazolone or a mixture of isothiazolones, for example, Kathon® CG/ICP preservative or Legend® MK preservative (Rohm and Haas Corporation) or Proxel™ BR preservative (Avecia Corporation). When present, the preservative is present in an amount of from about 0.001% to about 1% by weight of the total of all components in the insecticidal composition.

An especially preferred embodiment is an insecticidal composition that includes from about 15% to about 25% of unabsorbed bifenthrin, about 15% to about 25% of an absorbed crop protection agent as described herein, from about 1% to about 20% of hydrated aluminum-magnesium silicate and from about 0.02% to about 15% of at least one alkylpolyglycoside dispersant and optionally at least one additional dispersant selected from the group consisting of taurates, lignosulfonates, phosphate esters and polyvinylpyrrolidone, wherein all % are % by weight based upon the total weight of all components in the insecticidal composition.

Another embodiment is an insecticidal liquid fertilizer composition that includes unabsorbed bifenthrin, an absorbed crop protection agent as described herein, a hydrated aluminum-magnesium silicate, at least one alkylpolyglycoside dispersant and optionally at least one additional dispersant selected from the group consisting of taurates, lignosulfonates, phosphate esters and polyvinylpyrrolidone, and an aqueous-based liquid fertilizer. The liquid fertilizer is preferably present in a concentration of from about 95.00% by weight to about 99.99% by weight based upon the total weight of all components in the insecticidal liquid fertilizer formulation. The composition can further include at least one of an antifreeze agent, an anti-foam agent and a biocide.

Another especially preferred embodiment is an insecticidal liquid fertilizer composition that includes from about 0.75% to about 1.25% of unabsorbed bifenthrin, about 0.75% to about 1.25% of an absorbed crop protection agent as described herein, from about 0.05% to about 1.0% of hydrated aluminum-magnesium silicate, from about 0.1% to about 0.75% of at least one alkylpolyglycoside dispersant and optionally at least one additional dispersant selected from the group consisting of taurates, lignosulfonates, phosphate esters and polyvinylpyrrolidone, and from about 95% to about 99.99% of a liquid fertilizer, wherein all % are % by weight based upon the total weight of all components in the insecticidal liquid fertilizer composition.

The invention also provides a process for preparing a water dispersible insecticidal composition comprising: a) absorbing the crop protection agent onto a carrier, preferably precipitated silica; b) forming a mixture of bifenthrin or other high melting pyrethroid, a hydrated aluminum-magnesium silicate component, a dispersant component, and optionally, a preservative and/or biocide; and c) combining the mixture from step a) with that of step b).

Preferably, absorbing the crop protection agent onto a carrier comprises spraying the liquid crop protection agent onto the carrier. The liquid crop protection agent may be heated to reduce its viscosity to facilitate spraying the liquid, such as to a temperature from about 30 to about 80° C. The carrier may also be heated to facilitate absorption of the crop protection agent onto the carrier. Solid crop protection agents having melting points from about 20 to about 65° C. are heated to melt and liquefy the agents during spraying, such as to a temperature from about 70 to about 100° C. In a notable process, the absorption of the crop protection agent onto the carrier does not comprise using a liquid medium such as water or dispersants.

Step b) of the process for preparing a composition according to the present disclosure may comprise dispersing bifenthrin in a mixture of water and at least one dispersant, and optionally an antifreeze agent, an anti-foam agent and/or a biocide; wet milling the mixture to a particle size of about 0.1 to about 10 microns, preferably about 1 to about 5 microns in size, and adding a hydrated aluminum-magnesium silicate. In step c), the crop protection agent absorbed on a carrier prepared in step a) is mixed with the aqueous dispersion of bifenthrin until a homogeneous suspension is formed.

The process can further include the step of adding the resultant mixture, the insecticidal composition, to a liquid fertilizer. The insecticidal composition can be mixed with the liquid fertilizer in a tank mix, optionally with additional water, to provide an insecticidal liquid fertilizer composition in a desired concentration for application to the plant or locus of the plant. Alternatively, the insecticidal composition and the liquid fertilizer can be mixed and provided in a ready-to-use composition.

The present composition is effective against various insect pests and/or acarina pests. Insect pests and acarina pests to which the present composition can be applied are: Homoptera, which includes, for example, aphids, leafhoppers, cicadas, whiteflies, and mealybugs; Lepidoptera, which includes, for example, butterflies, moths and skippers; Coleoptera, which includes, for example, beetles and weevils; and Acarina, which includes, for example, mites and ticks.

These insecticidal compositions may be applied to the areas in which control or suppression of insects is desired.

The invention also provides a method for controlling unwanted insects comprising applying an insecticidally effective amount of any of the compositions above to a locus where insect control is needed or expected to be needed.

The invention also provides a method of controlling unwanted insects and providing nutrients to plants, wherein the method includes applying to an area infested with such insects and containing such plants an effective amount of a liquid fertilizer in combination with an insecticidal composition of this invention. Notably, the composition may be applied to the soil at the time of planting seeds or other plant propagation parts. Some embodiments provide a method of improving the growth of a plant by applying a plant growth effective amount of the composition to plant propagation material. In some embodiments, the plant propagation material is selected from seeds, spores, bulbs, cuttings, sets, rhizomes, tubers, meristem tissue, plant cells, and combinations thereof. In some embodiments, the plant propagation material includes at least one seed. In other embodiments, the composition is applied at a rate ranging from 0.1 g/ha to 1000 gm/ha.

The invention also provides for the use of any of the compositions described herein for controlling insects.

Embodiments of the methods and/or use include protecting plants in agricultural crops from insect damage by applying the effective dose of any of the compositions described herein to one or more parts of the plants to be protected and/or on the seeds of said plants before sowing and/or on the soil in which said plants grow.

Plants that may be treated with the compositions and in the methods of this invention include, but are not limited to, barley; brassicas, such as broccoli, Chinese broccoli, Brussels sprouts, cauliflower, Cavalo broccoli, kohlrabi, cabbage, Chinese cabbage and Chinese mustard cabbage; cilantro; coriander; corn, cucurbits, such as chayote, Chinese waxgourd, citron melon, cucumber, gherkin, gourd, muskmelons (including cantalope, casaba, crenshaw melon, golden pershaw melon, honeydew melon, honey balls, mango melon, Persian melon, pineapple melon, Santa Claus melon and snake melon), pumpkins, summer squash, winter squash and watermelon; cotton plants; dried beans and peas, including bean, field bean, kidney bean, lima bean, pinto bean, navy bean, tepary bean, adzuki bean, fava bean, blackeyed pea, catjang, cowpea, crowder pea, moth bean, mung bean, rice bean, southern pea, urd bean, broad bean, chickpea, guar, lablab bean, lentil, pea, field pea and pigeon pea; eggplant; lettuce; leafy brassicas/turnip greens including broccoli raab, bok Choy, collards, kale, mizuna, mustard spinach, rape greens and turnip greens; oats; oilseed rape; okra; peppers; rapeseed; rye; sod; soybeans; spinach; succulent peas and beans including pea, dwarf pea, edible-pod pea, English pea, garden pea, green pea, snow pea, sugar snap pea, pigeon pea, bean, broadbean, fava bean, lima bean, runner bean, snap bean, wax bean, asparagus bean, yardlong bean, jackbean and sword bean; sunflowers; tobacco; tomatoes; tuberous and corm vegetables including potato, sweet potato, arracacha, arrowroot, Chinese artichoke, Jerusalem artichoke, edible canna, cassava, chayote, chufa, dasheen, ginger, leren, tanier, turmer, yam bean and true yam; and wheat. In some embodiments, the plant is selected from corn, cotton, soybean, sunflower, wheat, barley, rye, oat, and oilseed rape.

In use by the farmer on the field, the compositions described herein may be diluted with water in a tank mix to give a concentration of active ingredient in the range of for example 0.1% or 0.2% to 1.5% or 2%. Additional wetting agent and/or oil may be added to the tank mix to facilitate dispersion on the foliage of the plant.

The compositions of the invention are further illustrated by the following Examples. These Examples serve only to illustrate the invention and should not be interpreted as limiting the scope of the invention in any way, since further modifications encompassed by the disclosed invention will be apparent to those skilled in the art. All such modifications are deemed to be within the scope of the invention as defined in the present specification and claims.

### EXAMPLES

### Example 1

Bifenthrin/Absorbed Chlorpyrifos Liquid Fertilizer Ready Formulation (Composition A)

Step A: Absorbing Chlorpyrifos on Silica

A Processall 140 liter plow blender (Processall Inc) is heated to a temperature of about 100° C., then charged with 5.5 kilograms of pre-heated (100° C.) precipitated silica (HilSil® ABS). Technical chlorpyrifos (8 kilograms, 96-98% purity) is heated to 80° C. and charged to a pre-heated pressure spray canister. The plow blender is started and the hot chlorpyrifos is sprayed onto the tumbling silica. Blending is continued for about 15 minutes after the addition is completed. The resultant coated silica is transferred to a plastic storage bag and allowed to cool to room temperature and then sealed, to yield 12.5 kilograms of chlorpyrifos coated silica (59% loading).

Step B. General Procedure for Preparation of a Bifenthrin Composition

An amount of 47.67 weight % of water is combined with 9.5 weight % of propylene glycol, 7.0 weight % of sodium methyl oleoyl taurate (Geropon® T77, available from Solvay Novecare, Princeton, N.J.), 8.0 weight % of C₉-C₁₁ alkyl d-glucopyranoside (Agnique® PG9116 available from Cognis Corporation in Cincinnati, Ohio), 0.3 weight % of silicone antifoam emulsion (Xiameter® AFE-0100 available from Dow Corning Corp. in Midland, Mich.) and 0.1 weight % of an isothiazolinone compound (Kathon® CG/ICP available from Rohn and Haas Co. in Philadelphia, Pa.) and the mixture was agitated. To this mixture was added 17.43 weight % of bifenthrin technical material. The resultant mixture was milled to less than 9 microns and then 10 weight % of attapulgite clay (Attaflow® FL available from Englehard in Iselin, N.J.) was added to modify the final viscosity.

Step C. A mixture of 50 grams of chlorpyrifos absorbed onto silica prepared as in Step A and 100 grams of the bifenthrin suspension prepared as in Step B is stirred in a beaker until homogenous.

The physical stability of the example compositions is tested by mixing the composition with a 10% nitrogen-34% phosphorous-0% potassium liquid fertilizer (aqueous) at a 5% to 95% weight ratio and observing the mixture's physical stability in a 500 milliliter/50 cm chromatography column. The stability of the test composition is compared with that of a traditional bifenthrin composition known in the art, TALSTAR® 2EC (available from FMC Corporation) that is mixed at a 5% to 95% ratio by weight with a 10-34-0 aqueous liquid fertilizer. To a glass cylinder are added 95 grams of a 10-34-0 aqueous liquid fertilizer and 5 grams of the Example composition or TALSTAR® 2EC. The glass cylinder is sealed and inverted 30 times to mix the components. The test mixture is poured into a glass chromatography column and a ten-ml sample was withdrawn at ten minute intervals for one hour. The samples were analyzed by HPLC to determine the amount of bifenthrin in each sample in parts per million.

The test data indicate that TALSTAR® 2EC is not homogenous and has poor physical stability when mixed with high phosphorus aqueous-based liquid fertilizer. Example compositions are homogenous throughout the test, indicating good physical stability.

While this invention has been described with an emphasis upon preferred embodiments, it will be obvious to those of ordinary skill in the art that variations in the preferred compositions and methods can be used and that it is intended that the invention can be practiced otherwise than as specifically described herein. Accordingly, this invention includes all modifications encompassed within the spirit and scope of the invention as defined by the claims that follow.

What is claimed:

1. An insecticidal composition comprising a) bifenthrin; b) at least one additional crop protection agent absorbed on a carrier, wherein the crop protection agent comprises a liquid at ambient temperature and pressure, or a low-melting solid having a melting point from about 20° C. to about 65° C.; c) a hydrated aluminum-magnesium silicate; and d) at least one alkylpolyglycoside dispersant and optionally at least one additional dispersant selected from the group consisting of taurates, lignosulfonates, phosphate esters and polyvinylpyrrolidone.

2. The insecticidal composition of claim 1 comprising a) about 1% to about 35% of bifenthrin; b) about 1% to about 30% of at least one crop protection agent absorbed on a carrier; c) about 1% to about 20% of hydrated aluminum-magnesium silicate; and d) about 0.2% to about 20% of the dispersant component; where all % are % by weight based upon the total weight of all components in the composition.

3. The insecticidal composition of claim 1 or claim 2 wherein d) consists essentially of the at least one alkylpolyglycoside dispersant.

4. The insecticidal composition of claim 1 or claim 2 wherein d) comprises at least one alkylpolyglycoside dispersant and a taurate dispersant.

5. The insecticidal composition of claim 1 or claim 2 wherein d) comprises at least one alkylpolyglycoside dispersant and a lignosulfonate dispersant.

6. The insecticidal composition of claim 1 or claim 2 wherein d) comprises at least one alkylpolyglycoside dispersant and a phosphate ester dispersant.

7. The insecticidal composition of claim 1 or claim 2 wherein d) comprises at least one alkylpolyglycoside dispersant and a polyvinylpyrrolidone dispersant.

8. The insecticidal composition of any one of the preceding claims wherein the crop protection agent absorbed on the carrier is a liquid at ambient temperature and pressure.

9. The insecticidal composition of any one of the preceding claims wherein the crop protection agent absorbed on the carrier is a low-melting solid having a melting point from about 20° C. to about 65° C.

10. The insecticidal composition of any one of the preceding claims wherein the crop protection agent absorbed on the carrier is a low-melting solid having a melting point less than 60° C.

11. The insecticidal composition of any one of the preceding claims wherein the crop protection agent absorbed on the carrier is a low-melting solid having a melting point less than 50° C.

12. The insecticidal composition of any one of the preceding claims wherein the crop protection agent absorbed on the carrier comprises an insecticide selected from the group consisting of azinphos-ethyl, beta-cypermethrin, chlorpyrifos, esfenvalerate, fenoxycarb, fenvalerate, gamma-cyhalothrin, monocrotophos, pyridaphenthion, resmethrin, thiofanox, triazamate and zeta-cypermethrin.

13. The insecticidal composition of any one of the preceding claims wherein the crop protection agent absorbed on the carrier comprises an insecticide selected from the group consisting of chlorpyrifos, gamma-cyhalothrin and zeta-cypermethrin.

14. The insecticidal composition of any one of the preceding claims wherein the crop protection agent absorbed on the carrier comprises a fungicide selected from the group consisting of dinocap, fenpropidin, fenpropimorph, imazalil, myclobutanil, nitrothal-isopropyl, penconazole, propamocarb hydrochloride, pyraclostrobin, spiroxamine, and propiconazole.

15. The insecticidal composition of any one of the preceding claims wherein the crop protection agent absorbed on the carrier comprises a fungicide selected from the group consisting of pyraclostrobin and propiconazole.

16. The insecticidal composition of any one of the preceding claims wherein the crop protection agent absorbed on the carrier comprises a nematicide selected from the group consisting of cadusafos, dichlofenthion, ethoprophos, fensulfothion, fosthiazate, heterophos, isazofos, thionazin, mecarphon, fenamiphos, phosphocarb and benclothiaz.

17. The insecticidal composition of any one of the preceding claims wherein the hydrated aluminum-magnesium silicate is selected from the group consisting of montmorillonite and attapulgite.

18. The insecticidal composition of any one of the preceding claims wherein the carrier comprises clay, synthetic amorphous silica gel, hydrophilic silica, precipitated silica, or mixtures thereof.

19. The composition of any one of the preceding claims, further comprising at least one additive selected from the group consisting of antifreeze agents, anti-foam agents and biocides.

20. The insecticidal composition of any one of the preceding claims further comprising a liquid fertilizer in an insecticidal liquid fertilizer composition.

21. The insecticidal liquid fertilizer composition of claim 20 wherein the liquid fertilizer is present in a concentration of about 95.0% by weight to about 99.99% by weight based on the total weight of all components in the insecticidal liquid fertilizer composition.

22. The insecticidal liquid fertilizer composition of claim 20 comprising bifenthrin in about 0.75% to about 1.25%, the crop protection agent absorbed on a carrier in about 0.75% to about 1.25%, the hydrated aluminum-magnesium silicate in about 0.05% to about 1.0%, and the dispersant in about 0.1% to about 0.75% by weight based on the total weight of all components in the insecticidal liquid fertilizer composition.

23. The composition of any one of the preceding claims, further comprising at least one additive selected from the group consisting of antifreeze agents, anti-foam agents and biocides.

24. A process for preparing the insecticidal composition of any of claims 1 to 23 comprising: a) absorbing the crop protection agent onto a carrier; b) forming a mixture of bifenthrin, a hydrated aluminum-magnesium silicate component, a dispersant component, and optionally, a preservative and/or biocide; and c) combining the mixture from step a) with that of step b).

25. A method for controlling insects comprising applying an insecticidally effective amount of the composition of any of claims 1 to 23 a locus where insect control is needed or expected to be needed.

26. A method of controlling unwanted insects and providing nutrients to plants, wherein the method includes applying to an area infested with such insects and containing such plants an effective amount of a liquid fertilizer in combination with the insecticidal composition of any of claims 1 to 23.

27. The invention also provides a use of the insecticidal composition of any of claims 1 to 23 for controlling insects.
